(19) United States
(12) Patent Application Publication
(10) Pub. No.: US 2006/0179671 A1
(43) Pub. Date: Aug. 17, 2006

(54) Garage parking guide

(76) Inventor: Sudip Ghatak, East Brunswick, NJ (US)

Correspondence Address: LAW OFFICES OF ARTHUR E. JACKSON, P.O. BOX 88, HOPEWELL, NJ, 08525, US

(21) Appl. No.: 11/058,545

(22) Filed: Feb. 15, 2005

(51) Int. Cl. G01D 21/00

(52) U.S. Cl. 33/264

(57) ABSTRACT

Provided, among other things, is a device for aligning a motor vehicle in a parking space comprising a light projector for mounting above an the parking space comprising one or more light sources for projecting one or more lines extending from the parking space to outside the parking space, with the lines parallel to the intended vehicle alignment for approaching the parking space.

The present invention relates to among other things, a device and method of guiding a motor vehicle into a confined space.

Parking larger automobiles in the home garage is a most common and difficult challenge today. There are several reasons for this. The significant width and length of many current automobiles contribute to the effort to park. As the width of many automobiles is often only slightly less than the width of garages, simply entering the garage without damaging the vehicle, or the garage frame, is a challenge. Moreover, the angle of entry is often indirect and, with angular entry, space on the side of the garage becomes critical. The problem of angular entry is compounded by the limited width of home garages. In practice, entry into the garage without assistance is difficult. To achieve a proper approach alignment to avoid the sides of a garage door frame, the operator must begin aligning the automobile outside the garage, i.e., prior to entry.

While a number of devices and methods have been described that assist in parking, in general these inventions assist the driver within the garage. These devices are, in general, mechanical or optical devices, such as laser pointers, that confirm the spacing of a vehicle relative to an interior wall.

Existing technologies do not provide a means for alignment prior to entry into the garage. Specifically, there is a need for parking assistance providing alignment assistance outside of the garage, such as one or two car lengths in advance of the garage door. Here we describe, among other things, a device for aligning a vehicle prior to entry into a garage as well as to maintain the alignment into the garage and to a parking position without contact with garage walls or the garage door structure.

### SUMMARY OF THE INVENTION

In one embodiment, the invention relates to a device for aligning a motor vehicle in a parking space comprising a light projector for mounting above an the parking space comprising one or more light sources for projecting one or more lines extending from the parking space to outside the parking space, with the lines parallel to the intended vehicle alignment for approaching the parking space.

In another embodiment, the invention provides method of aligning a motor vehicle in a parking space comprising: electrically activating one or more light sources for projecting onto ground light defining two or more parallel lines extending from the parking space to outside the parking space, with the lines parallel to the intended vehicle alignment for approaching the parking space; and operating the vehicle to align with the lines and move into the parking space.

### BRIEF DESCRIPTION OF THE DRAWINGS

FIG. 1 displays a guideway illuminator in use with a garage.

FIG. 2 shows a top view of a guideway illuminator in use with a garage.

FIG. 3 shows a side view of a guideway illuminator in use with a garage.

FIG. 4 shows some light projector features that can be used to project the grid pattern.

### DETAILED DESCRIPTION OF THE INVENTION

The guideway illuminator of the invention projects a grid pattern (e.g., a series of lines) on the ground at and in front of the intended parking space, which serves as a guide so that cars can reliably approach the space, avoiding for example garage structure. The series of lines can, in some embodiments, be adjusted to fit the width of any vehicle.

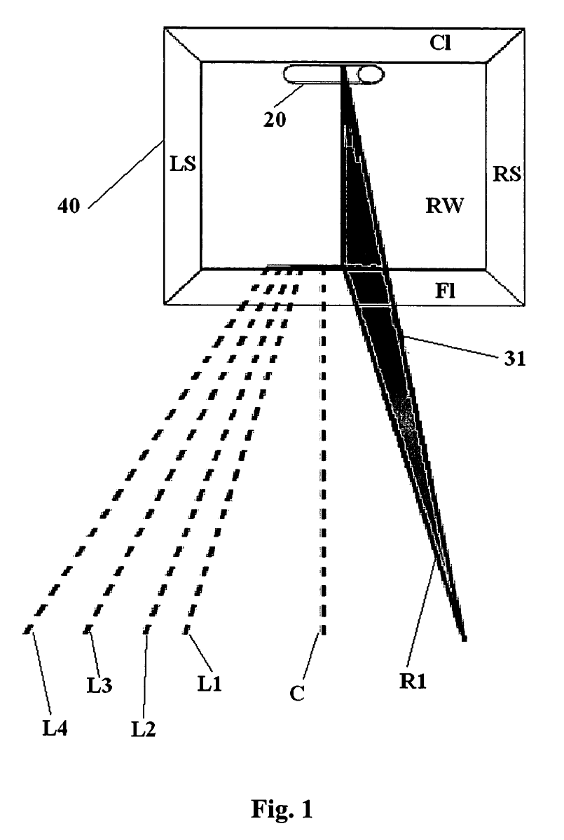

FIG. 1 shows a guideway illuminator 20, which projects beams 31 that illuminate lines such as projection line R1. The guideway illuminator 20 is shown (in somewhat exaggerated perspective view) in reference to garage 40, with floor F1, sidewalls LS, RS and RW, and ceiling C1. Prospective projection line locations L1, L2, L3 and L4 illustrate that the distance of the lines from a centerline C can differ from guideway illuminator to guideway illuminator or can be adjustable. A projection line can also be projected at centerline C. These projection lines can be used as visual guides, or light detectors in the vehicle can use them in conjunction with computer controls for the vehicle to establish an approach pathway. Associated equipment can be devices that give visual or auditory cues or a complete servo-like system. In other words, the guideway illuminator can be used to allow a vehicle to park itself if needed. The lines can be in the visible spectral, IR, RF or in other appropriate spectral space. The invention can be used in conjunction with guiding any mobile object.

In some embodiments, a single projection line can be used. For single projection line embodiments, the projection line can be favorably adapted to intersect a portion of the motor vehicle, such as a hood, to provide an orienting line.

Projection lines can be made up of a series of points defining a line. By using discrete light beams, light intensity at any one point in the projection line can be increased, thereby increasing visibility, such as during daylight hours. The projection lines are typically defined by the intersection of a plane (such as beam 31) with the ground. The projection lines formed on the ground often provide the visual clues for aligning a motor vehicle. However, where the projection plane intersects the motor vehicle, lines formed on the vehicle and detected visually or with optical detectors can provide the guidance.

The parallel projection lines are substantially parallel to the intended vehicle alignment for approaching the parking space. For example, the lines may be parallel, or 5° offset from parallel.

Projection lines can include, for example, a projection line R1 and a projection line L1, which in one embodiment are approximately equidistance from the centerline C. These projection lines can, for example, be spaced to indicate the location and intended orientation of the motor vehicle's tires. In one embodiment, the projection lines are approximate aligned with the outer rims of the motor vehicle's front tires. In one embodiment, the projection lines are set at a separation selected to be within about 5, 6, 7, 8, 9, 10, 11 12, 13, 14 or 15% of the vehicle widths of a significant segment of 2004 vehicles classified in one of the following classifications: Large Luxury Cars, Midsize Luxury Cars, Large Family Cars, Midsize Moderately Priced Cars, Midsize Inexpensive Cars, Small Cars, Large SUVs, Midsize SUVs, Small SUVs, Large Pickups, Small Pickups, and Passenger Vans. In some embodiments, two parallel projection lines are used on each side of the centerline, for example to visually mimic the width of the motor vehicle's front tires.

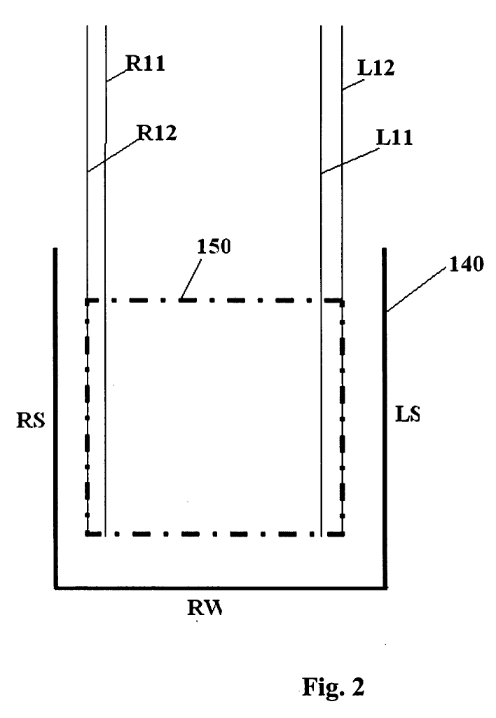

FIG. 2 shows a top view of another garage 140, with two sets of projection lines. On the right side, projection lines R11 and R12, and, on the left side, projection lines L11 and L12. Box 150 shows the intended parking space.

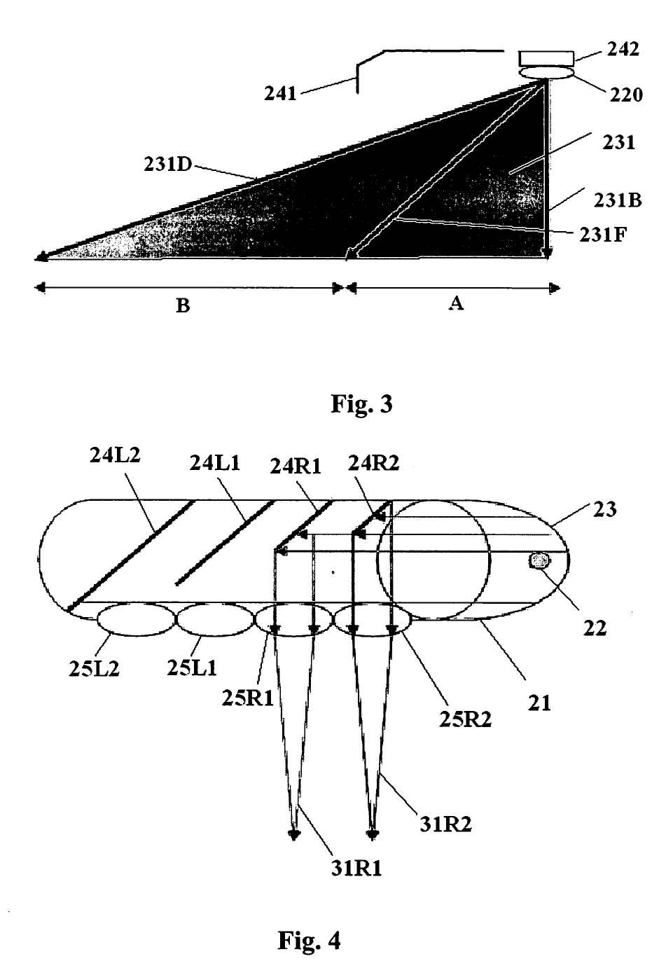

FIG. 3 shows an embodiment where guideway illuminator 220 is electrically connected to a garage door opener 242, such as through an outlet or through a light outlet associated with the garage door opener 242. Garage door 241 is in an “up” position. In this option, the guideway illuminator 220 is activated when the garage door opener is activated, such as by remote (operated, for example, by Rf or sound). The guideway illuminator can be automatically activated in other ways, such as with a motion detector, proximity sensor, electromagnetic detector, or the like. (Note that the guideway illuminator does not raise the same security issues as might a garage door opener.) Beam 231 has a back end 231B (in this exemplary option, aimed straight down), and segment 231F (which cannot necessarily be distinguished) aimed at the front of the intended parking space, and an outer edge 231D. Segment A is within the intended parking space. Segment B is outside the intended parking space. Segment B can be, for example, one to two lengths of the length of the motor vehicle intended to be parked. Segment B can be, for example, one of the following lengths or longer: 10, 12, 14, 16, 18, 20, 22, 24, 26 or 28 ft. Segment B can be, for example, one of the following lengths or shorter: 12, 14, 16, 18, 20, 22, 24, 26, 28, 30, 32, 34, 36, 38 or 40 ft.

Segment A, the segment with the intended parking space that is illuminated, can be, for example, one of the following lengths or longer: 5, 6, 7, 8, 9, 10, 11, 12, 13, 14, 15, 16, 18 or 20 ft. Segment A can be, for example, one of the following lengths or shorter: 12, 14, 16, 18, 20, 22, 24, 26, 28 or 30.

As can be envisioned from FIG. 3, the back end 231B or some other designated portion of a beam can be used to establish the point at which a motor vehicle should be stopped. For example, in certain embodiments the back end 231B can be adjusted to intersect a useful reference point on a motor vehicle when the stopping point is reached. The guideway illuminator can include a separate light beam (and light source) for this purpose.

FIG. 4 shows a guideway illuminator the produces collimated beams 31 from a light source 21. Light from the initial light source 22 is reflected by parabolic reflector 23, and diverted to make the beams by an array of mirrors 24. These mirrors can be shaped as the final design requires. The mirrors 24 can be adjusted to accommodate varying widths of different vehicles. The mirrors 24 perform two functions: they parse the light into an array of beams and direct the beams toward a designated set of lenses 25. These lenses 25 may be an array of ordinary lenses, toroidal-shaped, or any other appropriate shape. The lenses in the array can take each beam and increase its focus or create an array of dots, dashes or the like.

Where fewer primary light sources are used than the number of intended beams, is a need to parse the light and then form the beams. The image created by the beam is, in certain embodiments, bright, and avoids the inefficiency of shadow casting. One form of shadow casting is the projection of an image. In such embodiments, the design should seek to use all the light to illuminate a line. Where the light is not directed, we should have darkness. Of course, some ambient lighting may be present, e.g., streetlights. In certain embodiments, the projected lines are bright enough to be seen in daylight on concrete, asphalt, gravel, paving stones, brick or grass.

To reduce cost it can be beneficial to combine the turning-mirror/parser and the lens array into a single item. To do this, in one embodiment, the mirror surfaces with dimples that act as off-axis parabolic mirrors. As the focal lengths needed are relatively long, these would be shallow dimples.

Alternative configurations are, of course, possible. For example an elliptically shaped diverging beam can be made to impinge upon a “dimpled” cylinder. As each dimple sees an almost collimated beam, it will behave as described above. The direction that each dimple points varies, and as the direction of incidence varies as well, the formed outgoing beams will splay out into the desired directions and form “spots” at the desired distances from the illuminator. To the extent practical, designs should seek to reduce the wattage requirement placed upon the illuminating source by directing the light to only those points in space where the light is needed. Thus we don't have an imaging system in the classical sense, but rather a structured illuminator.

Included among alternative designs are designs that use one or more light sources for each beam. For example, LEDs or solid-state lasers can be used. These light sources can be split, to create multiple point beams (forming all of a planar “beam” 31), or one light source can be used per point beam.

Where lighting or sources or optical elements can be adjusted to adjust their placement in relation to the intended parking space, they can be on a track. A track can include a screw drive or screw drives for moving such elements. A track may be composed of separate component tracks, such as for movement on each side of the centerline. The guideway illuminator can have markings to indicate certain preferred adjustment positions, such as those designated as appropriate for various categories of vehicles.

Definitions

The following terms shall have, for the purposes of this application, the respective meanings set forth below.

Motor Vehicle Categories

Certain motor vehicles can be categorized by vehicle class. The following classes shall be defined consistent with how the classifications were used by the Insurance Institute for Highway Safety for 2004 vehicles: Large Luxury Cars, Midsize Luxury Cars, Large Family Cars, Midsize Moderately Priced Cars, Midsize Inexpensive Cars, Small Cars, Large SUVs, Midsize SUVs, Small SUVs, Large Pickups, Small Pickups, and Passenger Vans.

Intended Parking Space

The intended parking space can be any space that fits the motor vehicle to be parked with a given alignment, plus space parallel to the aligned vehicle and outside the motor vehicle width where a projection line of light according to the invention can reasonably provide assistance in aligning the vehicle.

Motor Vehicle Width

For the purposes of this application, motor vehicle width for vehicles having two front tires is the width from the outside edges of the two front tires.

Significant Segment of a 2004 Vehicle Class

A significant segment of a 2004 vehicle class is about 40% or more, or, if 40% do not fall within other qualifications set forth in the context, a fraction within 10% of the highest fraction that would meet those other qualifications (e.g., if 0.35 of such vehicles met the qualifications, a significant segment would be 0.35 minus 0.1×0.35=0.35−0.035=0.315).

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A device for aligning a motor vehicle in a parking space comprising a light projector for mounting above an the parking space comprising one or more light sources for projecting one or more lines extending from the parking space to outside the parking space, with the lines parallel to the intended vehicle alignment for approaching the parking space.

2. The device of claim 1, wherein each such parallel line is so defined by a series of beams of collimated light from the light projector.

3. The device of claim 1, wherein the light source(s) project two or more such parallel lines.

4. The device of claim 1, wherein the light source(s) project three or more such parallel lines.

5. The device of claim 1, wherein the light source(s) project four or more such parallel lines.

6. The device of claim 5, wherein four such parallel lines comprise two sets of adjacent parallel lines placed and spaced apart to indicate a preferred track for the motor vehicle's tires.

7. The device of claim 1, wherein two such parallel lines are set at a separation selected to be within about 10% of the vehicle widths of a significant segment of 2004 vehicles classified in one of the following classifications: Large Luxury Cars, Midsize Luxury Cars, Large Family Cars, Midsize Moderately Priced Cars, Midsize Inexpensive Cars, Small Cars, Large SUVs, Midsize SUVs, Small SUVs, Large Pickups, Small Pickups, and Passenger Vans.

8. The device of claim 1, further comprising a track along which lighting or optical devices can be moved to adjust the separation of two such parallel lines.

9. The device of claim 8, wherein the lighting or optical devices move along the track such that the parallel lines remain approximately equidistance from a center point.

10. The device of claim 1, wherein two such parallel lines extend about 10 feet or more from the intended parking space.

11. The device of claim 10, wherein said two such parallel lines extend about 5 feet or more within the intended parking space.

12. The device of claim 1, wherein projected lines are bright enough to be seen in daylight on concrete, asphalt, gravel, paving stones, brick or grass.

13. The device of claim 1, wherein a back end or other identifiable portion of one projected lines, or a separate light beam in the device, can be adjusted to establish an intersection with a designated place on the motor vehicle indicating a stopping location.

14. A system comprising the device for aligning a motor vehicle of claim 1, and electrical connections allowing the device to electrically connect to an outlet or light socket on a remotely or automatically operated second device.

15. A method of aligning a motor vehicle in a parking space comprising:
electrically activating one or more light sources for projecting onto ground light defining one or more parallel lines extending from the parking space to outside the parking space, with the lines parallel to the intended vehicle alignment for approaching the parking space; and
operating the vehicle to align with the lines and move into the parking space.

16. The method of claim 15, wherein the electrically activating comprises projecting two or more parallel lines extending from the parking space to outside the parking space.

17. The method of claim 15, where activating is accomplished with a remote activating device, motion detector or proximity sensor.

18. The method of claim 15, further comprising:
stopping the vehicle when a designated light beam or light beam portion intersects a designated location on the motor vehicle.
